(19) United States
(12) Patent Application Publication
(10) Pub. No.: US 2007/0044663 A1
(43) Pub. Date: Mar. 1, 2007

(54) Method for fabricating a hydrogen separation membrane on a porous substrate

(75) Inventors: Sun-Ju Song, Orland Park, IL (US); Tae H. Lee, Naperville, IL (US); Ling Chen, Woodridge, IL (US); Stephen E. Dorris, LaGrange Park, IL (US); Uthamalingam Balachandran, Hinsdale, IL (US)

Correspondence Address: HARRY M. LEVY;EMRICH & DITHMAR, LLC, 125 SOUTH WACKER DRIVE, SUITE 2080, CHICAGO, IL, 60606-4401, US

(73) Assignee: The University of Chicago, Chicago, IL (US)

(21) Appl. No.: 11/418,955

(22) Filed: May 5, 2006

Related U.S. Application Data
(60) Provisional application No. 60/711,961, filed on Aug. 25, 2005.
(60) Provisional application No. 60/711,962, filed on Aug. 25, 2005.
(60) Provisional application No. 60/711,963, filed on Aug. 25, 2005.

(51) Int. Cl. B01D 53/22

(52) U.S. Cl. 96/11

(57) ABSTRACT

A hydrogen permeable composition having a porous ceramic substrate, and a two part membrane adhered thereto. The two part membrane has a metal powder part and a ceramic oxide part, with the metal powder part being Ni, Pd, Pd alloys, Nb, Ta, Zr, V or mixtures thereof. The oxide part is yttria stabilized zirconia, shrinkable alumina, suitably doped cerates, titanate, zirconates of barium or strontium or mixtures thereof, and the hydrogen flux is at least 20 cm³ per minute-cm² at 500° C. in a 100% hydrogen atmosphere. A paste method of forming the composition is disclosed. A method of extracting hydrogen from a gas is also disclosed.

### RELATED APPLICATIONS

This application, pursuant to 37 C.F.R. 1.78(C), claims priority based on provisional application Ser. Nos. 60/711,961 filed on Aug. 25, 2005, 60/711,962 filed Aug. 25, 2005 and 60/711,963 filed Aug. 25, 2005.

The object of this invention is to provide dense composite metal and ceramic membranes that can nongalvanically separate hydrogen from other gaseous components and is an improvement to the membranes and methods disclosed in U.S. Pat. No. 6,569,226, the entire disclosure of which is incorporated by reference.

The United States Government has rights in this invention pursuant to Contract No. W-31-109-ENG-38 between the U.S. Department of Energy and The University of Chicago representing Argonne National Laboratory.

### FIELD OF THE INVENTION

This invention relates to a membrane and method for extracting hydrogen from fluids and, more particularly, this invention relates to a high-flow rate membrane and an improved method for extracting hydrogen from fluid without using electrical power or circuitry.

### BACKGROUND OF THE INVENTION

Global environmental concerns have ignited research to develop energy generation technologies which have minimal ecological damage. Concerns of global climate change are driving nations to develop electric power generation technologies and transportation technologies which reduce carbon dioxide emissions.

Hydrogen is considered the fuel of choice for both the electric power and transportation industries. While it is likely that renewable energy sources will ultimately be used to generate hydrogen, fossil-based technologies will be utilized to generate hydrogen in the near future.

The need to generate ever larger amounts of hydrogen is clear. Outside of direct coal liquefaction, other major industrial activities, such as petroleum refining, also require hydrogen. Collectively, petroleum refining and the production of ammonia and methanol consume approximately 95 percent of all deliberately manufactured hydrogen in the United States. As crude oil quality deteriorates, and as more stringent restrictions on sulfur, nitrogen and aromatics are imposed, the need for more hydrogen by the refining industry will increase.

Hydrogen production, as a consequence of other processes, is significant. A number of industries requiring hydrogen produce effluents containing significant amounts of unused hydrogen. However, this hydrogen requires clean-up prior to re-use. Furthermore, hydrogen is produced from the combustion of oil, methane, coal, and other petroleum-based materials. However, this hydrogen must be separated from other combustion gases, namely carbon dioxide, in order to be of use.

Petroleum refineries currently use cryogenics, pressure swing adsorption (PSA), and membrane systems for hydrogen recovery. However, each of these technologies has their limitations. For example, because of its high costs, cryogenics generally can be used only in large-scale facilities which can accommodate liquid hydrocarbon recovery. Membrane-based PSA systems require large pressure differentials across membranes during hydrogen diffusion. This calls for initial compression of the feed prior to contact to the upstream side of polymeric membranes and recompression of the permeate to facilitate final purification steps. Not only are these compression steps expensive, but PSA recovers less feedstream hydrogen and is limited to modest temperatures. U.S. Pat. No. 5,447,559 to Rao discloses a multi-phase (i.e. heterogenous) membrane system used in conjunction with PSA sweep gases.

The subject invention is an improvement of the '226 membranes providing higher hydrogen flux than previously obtained and providing an easier method of fabrication of the composite membranes.

### SUMMARY OF THE INVENTION

It is a principal object of the present invention to provide a hydrogen-separation membrane that is an improvement over the membranes of the prior art.

Another general object of the invention is to provide a membrane to extract hydrogen from a variety of fluids in which the membrane is made by a paste process hereinafter described which provides an improved hydrogen flux over prior art membranes.

Another object of the present invention is to provide a hydrogen permeable composition, comprising a porous ceramic substrate, and a two part membrane adhered to the porous ceramic substrate, the two part membrane having a metal powder part and a ceramic oxide part, the metal powder part being selected from Ni, Pd, Pd alloys, Nb, Ta, Zr, V or mixtures thereof, the oxide part being selected from yttria stabilized zirconia , shrinkable alumina, the cerates, titanates, zirconates of barium or strontium or mixtures thereof, wherein the metal powder part is present in the range of from about 20 to about 80 percent by volume of the membrane and the hydrogen flux is at least 20 cm³ per minute-cm² at 500° C. in a 100% hydrogen atmosphere.

Yet another object of the present invention is to provide a paste composition for forming a hydrogen permeable two part membrane, comprising a vaporizable liquid vehicle and a sinterable powder homogeneously dispersed therein, the powder including a metal powder part and a ceramic oxide powder part, the metal powder part being selected from Ni, Pd, Pd alloys, Nb, Ta, Zr, V or mixtures thereof, the oxide part being selected from yttria stabilized zirconia , shrinkable alumina, the cerates, titabates, zirconates of barium or strontium or mixtures thereof, wherein the metal powder part is present in the range of from about 20 to about 80 percent by volume of the membrane and the hydrogen flux is at least 20 cm³ per minute-cm² at 500° C. and at least 30 cm³ per minute-cm² at 900° C. in an 100% hydrogen atmosphere.

Still another object of the present invention is to provide a method of extracting hydrogen from a fluid stream containing hydrogen molecules, comprising contacting one surface of a two part membrane with the fluid stream thereby establishing a hydrogen molecule concentration gradient across the two part membrane, and passing hydrogen atoms through the two part membrane from the side of higher concentration to side of lower concentration, the two part membrane containing a metal powder part and a ceramic oxide part, the metal powder part being selected from Ni, Pd, Pd alloys, Nb, Ta, Zr, V or mixtures thereof, the oxide part being selected from yttria stabilized zirconia, a shrinkable alumina ,the cerates, titanates, zirconates of barium or strontium or mixtures thereof, wherein the metal powder part is present in the range of from about 20 to about 80 percent by volume of the membrane and the hydrogen flux is at least 20 cm³ per minute-cm² at 500° C. in a 100% hydrogen atmosphere.

A final object of the present invention is to provide an oxygen permeable composition, comprising a porous ceramic substrate, and a one part or a two part membrane adhered to or integral with the porous ceramic substrate, the one part membrane being selected from one or more of Sr(Fe_{1-y}Co_{y})Oₓ, or Sr(Fe_{1-y}Ti_{y})Oₓ or mixtures thereof, the two part membrane having a metal powder part and a ceramic oxide part, the metal powder part being selected from Ni , Ag, Fe, alloys or mixtures thereof, the oxide part being selected from CeO₂ doped with lower valence metal atoms, ZrO₂ doped with lower valence metal atoms, Sr FeCo_{0.5}Oₓ or mixtures thereof, wherein the metal powder part is present in the range of from about 20 to about 80 percent by volume of the membrane.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is SEM micrographs of dense ANL-3e film (˜13 and ˜50 micron thick films) on a porous alumina substrate;

FIG. 2 is an SEM of a secondary electron image of fracture surface of BCY/Ni thin film made by paste-painting method and sintered 10 hours at 1400° C. in 200 ppm H₂/balance N₂ atmosphere;

FIG. 3 is a graphical showing H₂ flux at 900° C. for polished Ni/BCY membrane and thin film Ni/BCY membrane made by paste-painting method as a function of pH₂ in feed gas with pH₂O=0.03 atm;

FIG. 4 is a graph H₂ permeation flux as a function of temperature for 17 micron thick film using 100% H₂ as feed gas;

FIG. 5 is a graph showing H₂ flux of polished ANL-3e membrane and ANL-3e thin films on porous Ni/BCY substrates;

FIG. 6 is a graph showing H₂ flux of ANL-3e thin films on porous Ni/BCY substrates as a function of temperature, one sintered only at 1400° C. (thickness=15 μm (the other sintered at 1400° C. and then at 1500° C. (thickness=13 μm);

FIG. 7 is a graph showing H₂ permeation flux as a function of pH₂for an ANL 3-e film;

FIG. 8(a) is an SEM illustrating the back scattered electron image of ANL-3e thin films on porous Ni/BCY substrates sintered only at 1400° C.;

FIG. 8(b) is an SEM illustrating the back scattered electron image of ANL-3e thin films on porous Ni/BCY substrates sintered at 1400° C. and then at 1500° C.; and

FIG. 9 is a graph showing the H₂ permeability of ANL-3e film (60 vol. % Pd) with thickness of ≈40 μm compared to permeability reported for Pd with same thickness;

### DETAILED DESCRIPTION OF THE INVENTION

Argonne National Laboratory (ANL) is developing two types of novel ceramic membranes for producing pure hydrogen: hydrogen transport membranes (HTMs) and oxygen transport membranes (OTMs), see Table 1. Both types of membrane are dense and produce hydrogen nongalvanically, i.e., they require neither electrodes nor an external power supply. HTMs produce hydrogen by separating it from mixed gases, e.g., product streams generated during coal gasification and/or methane reforming, whereas OTMs generate hydrogen by removing oxygen that is produced during the dissociation of water at moderate temperatures (<900° C.).

ANL Membrane Compositions

| Membrane | Matrix | Metal |
|---|---|---|
| ANL - 0 | BCY | — |
| ANL - 0b | SFC(SrFeCo_{0.5}Oₓ) | — |
| ANL - 0c | SFT(Sr_{1.0}Fe_{0.9}Ti_{0.1}Oₓ) | — |
| ANL - 1a | BCY | Ni |
| ANL - lb | CMO | Ni |
| ANL - lc | TZ-8Y | Ni |
| ANL - 1d | SFT(Sr_{1.0}Fe_{0.9}Ti_{0.1}Oₓ) | Ni |
| ANL - 2a | BCY | Pd |
| ANL - 2b | CMO | Pd/Ag(23 wt. %) |
| ANL - 3a | Al₂0₃ | Pd |
| ANL - 3b | BaTiO₃ | Pd/Ag |
| ANL - 3c | Al₂O₃ | Nb |
| ANL - 3d | Al₂O₃ | Pd/Ag(23 wt. %) |
| ANL - 3e | TZ-3Y | Pd |
| ANL - 3f | TZ-8Y | Pd |
| ANL - 3g | CaZrO₃ | Pd |
| ANL - 4a | Cu | Nb |

Notes:
BCY = BaCe_{0.8}Y_{0.2}O_{3-δ}
CMO = Ce₁₋ₓMₓO_{2-δ}(M Gd, Y)
TZ-3Y = ZrO₂ (3 mol. % Y₂O₃)
TZ-8Y = ZrO₂ (8 mol. % Y₂O₃)

Because the hydrogen flux through ANL-3 HTMs appears to be limited by the diffusion of hydrogen through the bulk, reducing the membrane thickness is expected to increase the hydrogen flux, or allow the same flux at lower temperatures. To increase the hydrogen flux through ANL membranes and/or reduce their operating temperature, the inventive paste process was used for fabricating dense membrane thin films.

This inventive method is paste-painting in which the porous substrate was prepared from a mixture of NiO and BCY. The substrate composition was mixed to give 45 vol. % Ni after sintering. To increase the porosity of the substrate, 5 wt. % graphite was added to the NiO/BaCe_{0.8}Y_{0.2}O₃₋₆ (BCY) mixture. The powder mixture was uniaxially pressed into cylindrical disks and then pre-sintered for 5 h at 700° C. in air. A highly viscous Ni/BCY paste was prepared by mixing Ni-BCY powder, an organic binder, and a plasticizer in isopropyl alcohol (IPA). To control the viscosity of paste, the amount of IPA was varied. The viscous paste was painted onto the NiO-BCY substrate using a brush, and then was dried at room temperature. The film thickness was controlled by varying the paste's viscosity and/or by the method of painting. The film was sintered at 1300-1400° C. in various atmospheres for 2-10 h.

Thin films of ANL-3e were prepared by a paste-painting wherein Pd and partially stabilized ZrO₂ (TZ-3Y) powders were mixed in a solution of α-terpineol and isopropyl alcohol with polyvinyl butyral (PVB) as a binder and dibutyl phthalate (DBP) as a plasticizer. The viscosity of the paste was controlled by varying the concentration of isopropyl alcohol. The pastes were prepared to give either 50 vol. % Pd or 60 vol. % Pd in the final thin film and is preferred.

Porous substrates were made from either Al₂O₃ or a NiO/TZ-3Y mixture. Two types of Al₂O₃ powder were tested and eliminated from further consideration, because one powder densified completely during sintering, and the other powder did not shrink during sintering. Low shrinkage of the substrate during sintering is a problem, because it hinders densification of the thin film. A third type of Al₂O₃ powder contained about 10 wt. % water, and experienced high shrinkage during sintering of the ANL-3e film that was deposited on it. The high shrinkage of the substrate was considered beneficial to densification of the thin film.

Another type of porous substrate was prepared from a mixture of NiO/TZ3Y mixture whose composition was controlled to give 50 vol. % Ni in the substrate after the NiO was reduced. The powder mixture was milled in isopropyl alcohol for 24 h, then the alcohol was evaporated, and the dried powder was sieved using a 120-mesh sieve. The sieved powder was uniaxially pressed at a pressure of 200 MPa into disks that were partially sintered for 5 h at 900° C. in air. ANL-3e thin films were brushed onto partially sintered substrates composed of either Al₂O₃ or NiO/TZ-3Y. The substrates and their ANL-3e films were then sintered in air either at 1500° C. for 10 h or 1400° C. for 5 h. Films on NiO/TZ-3Y substrates were heated in 80% H₂/balance He at 600° C. just before hydrogen flux measurements were made in order to reduce NiO to Ni metal. During the reduction of NiO, the hydrogen flux at 600° C. increased as porosity developed in the substrate. When the flux became constant at 600° C., the reduction of NiO was considered complete.

Sr—Fe—Co—O (SFC) powder for ANL-0b membranes was purchased from Praxair, whereas Sr—Fe—Ti—O (SFT) powder for ANL-1d membranes was prepared at ANL by conventional solid-state reaction between its constituent oxides. To prepare ANL-1d membranes, SFT powder was first mechanically mixed with Ni powder (avg. particle size ≈0.1 μm). Powder for ANL-1b membranes was made by reducing a NiO/Ce₁₋ₓGdₓO_{2-δ}(CGO) powder mixture (Praxair) to form Ni/CGO. Disk-shaped membranes were prepared by uniaxially pressing the powders and then sintering the disks in 200 ppm H₂/balance N₂ for 10 h at 1150° C. (ANL-1b), 1200° C. (ANL-0b), and 1350° C. (ANL-1d).

A JEOL 5400 scanning electron microscope (SEM) was used to evaluate the microstructure of membranes and to measure their thickness. To prepare OTMs for hydrogen production rate measurements, both sides of sintered disks were polished using 600-grit SiC polishing paper. Thin film HTMs were tested in their as-sintered condition. The procedures for measuring hydrogen permeation and hydrogen production rate are similar, and are known in the art. Unless noted otherwise, hydrogen was used as a model gas to establish a high pO₂ gradient across the membrane for measuring the hydrogen production rate.

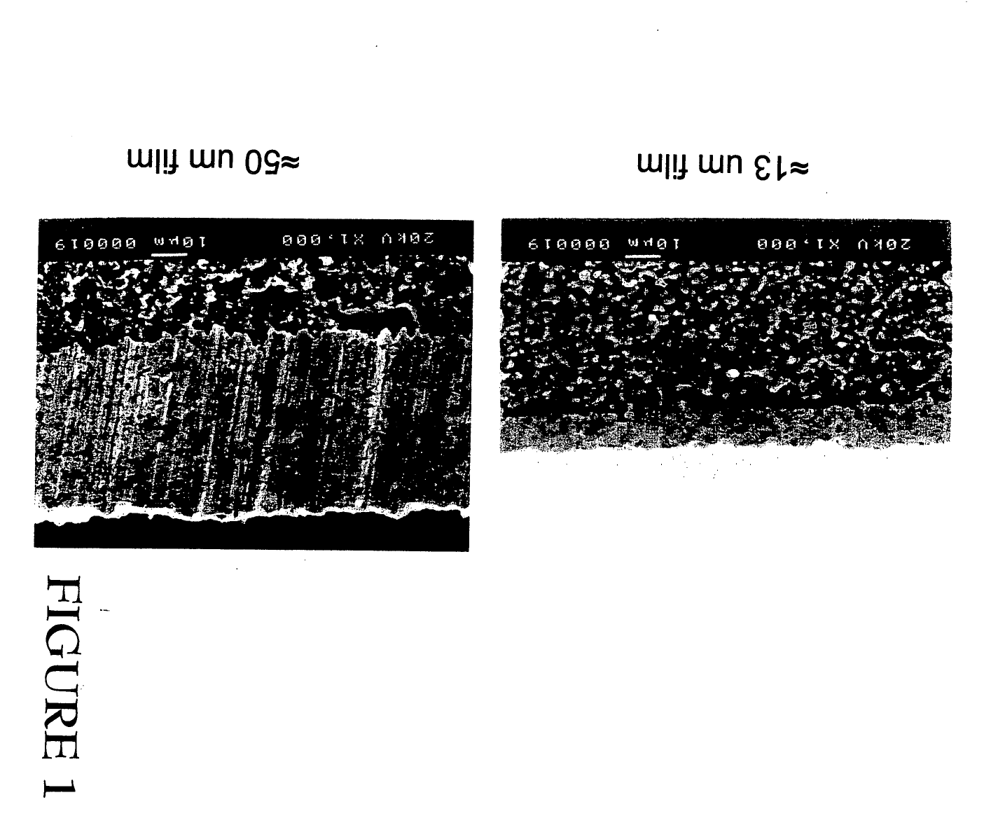

FIG. 1 shows the SEM micrographs of dense ANL-3e films (about 13 and 50 μm thick films) on porous alumina substrate. The film thickness could be easily controlled by adjusting number of paste painting steps.

In general thicknesses between 5 and 50 microns can be made with the inventive process, but thinner films improve hydrogen flux, so films less than about 20 microns are preferred and films about 10 microns thick are most preferred.

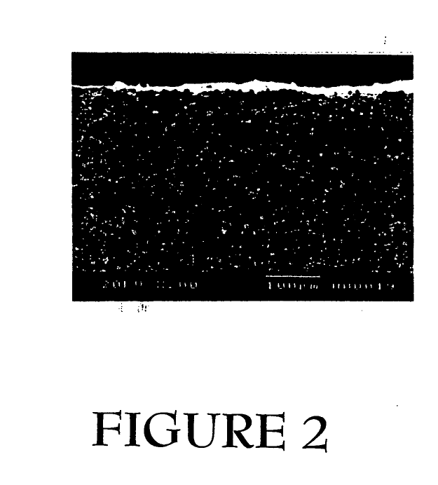

FIG. 2 shows the cross-section of a BCY/Ni thin film made by the paste-painting method. The film was dense and appeared free of cracks. A Ni-rich layer was not observed at the interface between the film and substrate. The thickness (8 μm) of the film might be reduced by lowering the viscosity of the Ni/BCY suspension; however, reducing the viscosity too much could promote segregation of the Ni phase. The substrate was porous after the NiO was fully reduced in 4% H₂/balance He, and the film was nearly flat with a very slight warp toward the film side. The warp might have been caused by different densification rates for the substrate and film (due to differences in particle packing in the film and substrate), because Ni/BCY (in the film) densifies more readily than NiO/BCY (in the substrate), or because pre-sintering reduced the substrate's densification rate.

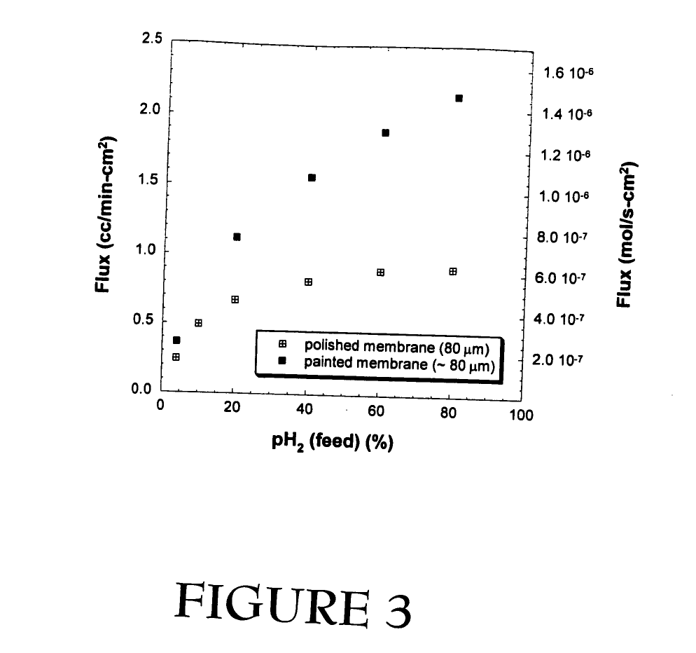

FIG. 3 shows the hydrogen flux through a painted Ni/BCY film versus pH₂ (feed), the partial pressure of H₂ in the feed gas, which was humidified to give pH₂O=0.03 atm. The leakage rate during these measurements was about 7-15% of the measured hydrogen concentration. It is believed that the slight warp and unpolished surface of the film gave a poor seal, which caused the relatively high leakage rate. The hydrogen flux is higher for the thin film on a porous substrate than for a polished membrane of the same thickness, probably because the porous substrate provides additional sites for activating hydrogen adsorption and ionization. We have seen a similar effect of porous layers on the hydrogen production rate by water splitting using OTMs. The preferred membrane compositions for OTMs are Sr(Fe_{1-y})Co_{y}Oₓ or Sr(Fe_{1-y}Ti_{y})Oₓ and the preferred metal for a two part membrane is Ni.

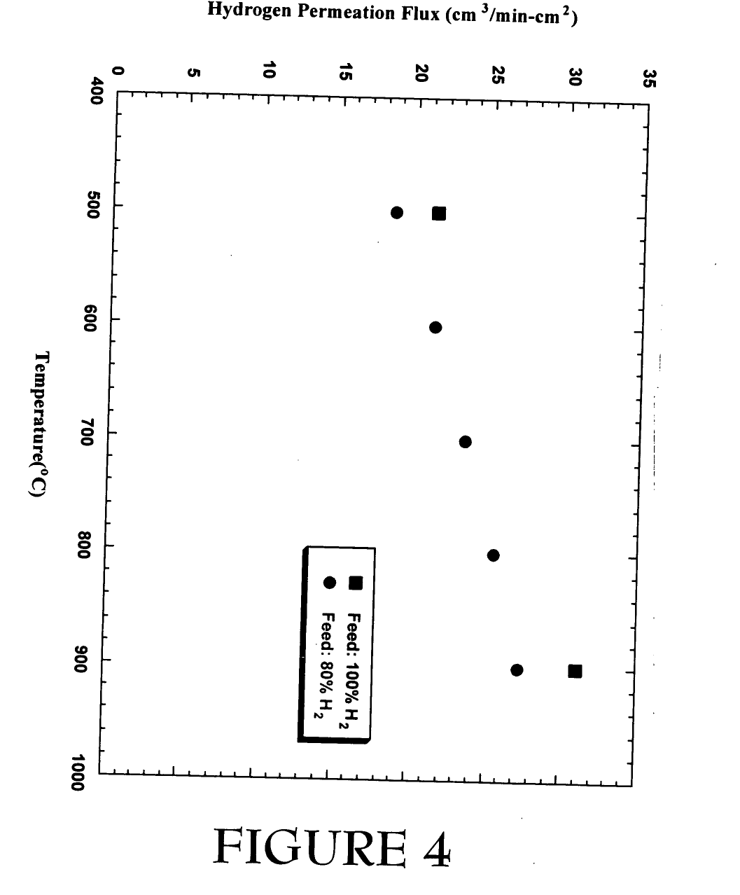

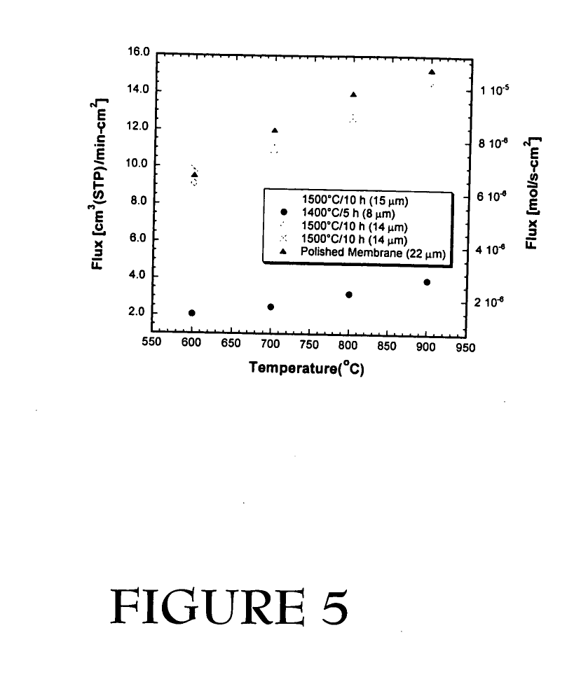

The results from hydrogen flux measurements are given in FIGS. 4 and 5 as a function of temperature in FIG. 5, for four ANL-3e (50 vol. % Pd) thin films on porous NiO/TZ₃Y substrates. The thickness of the films and their sintering conditions are shown in the figure. The thickness of each film was <15 μm. Three of the films were sintered for 10 h in air at 1500° C., and the fourth was sintered for 5 h in air at 1400° C. For the three films sintered at 1500° C., individual values differed from the average value by about 10%, which indicates that the reproducibility of the paste-painting method is comparable to that for bulk membranes. The highest flux (14.5 cm³(STP)/cm²-min) was measured at 900° C. with a feed gas of 80% H₂/balance He using a film sintered at 1500° C. with thickness of 14 μm. This flux is lower than that for a 22-μm-thick bulk membrane of the same composition, but is much higher than that for the film sintered at 1400° C.

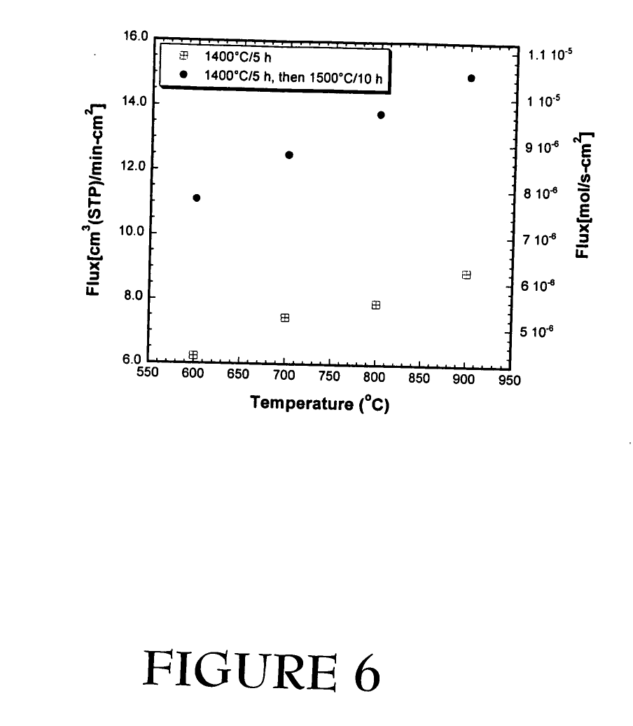

Hydrogen flux measurements during reduction of the substrate suggest that the effect of sintering temperature on hydrogen flux might be related to the size of pores in the substrate. Because porosity increased during reduction and improved hydrogen transport through the substrate, the hydrogen flux increased with time until the substrate was fully reduced, at which point the flux stopped increasing. Films sintered at 1500° C. were reduced in 3 h, whereas the film sintered at 1400° C. needed 12 h to be reduced. Because interconnected pores in the substrate aid reduction of NiO, the longer time to reduce the film sintered at 1400° C. suggests that it had either lower porosity, or smaller pores, than films sintered at 1500° C. Films sintered at a lower temperature should not be less porous than films sintered at a higher temperature, but sintering at a lower temperature could yield smaller grains of NiO, which would produce smaller pores after the NiO was reduced. Smaller pores could impede hydrogen transport through the substrate and could cause concentration polarization due to inefficient removal of the retentate from the pores. Both effects would give an overall lower flux to the sample sintered at lower temperature. The effect of sintering temperature was confirmed in a test using two other ANL-3e films (60% Pd) that had similar thickness and were both initially sintered in air for 5 h at 1400° C. The flux was measured for one of the films after it was sintered at 1400° C., whereas the other film was re-sintered at 1500° C. for 10 h before its flux was measured. As shown in FIG. 6, the film re-sintered at 1500° C. gave a much higher flux.

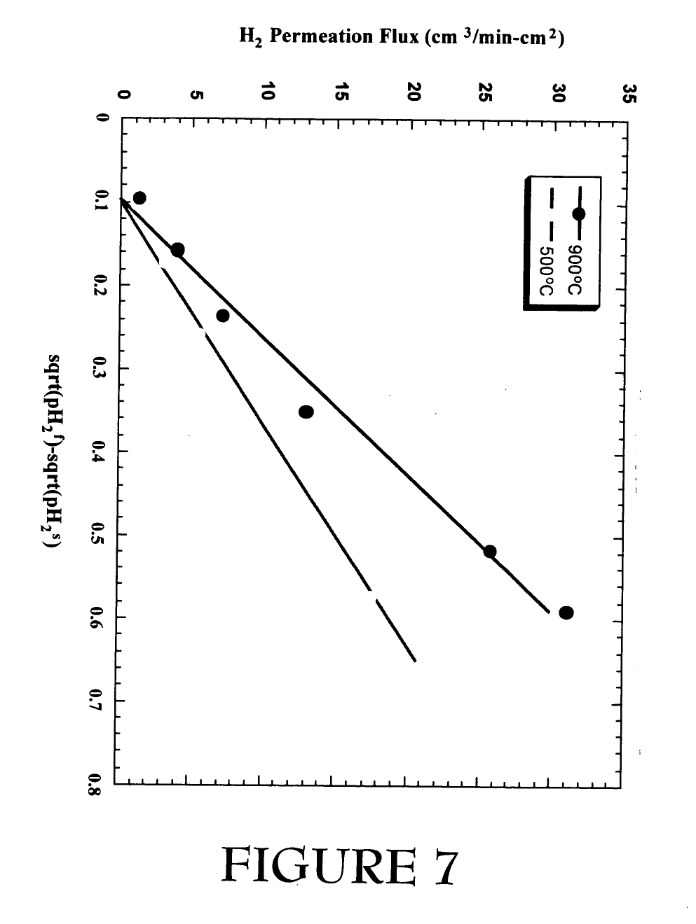

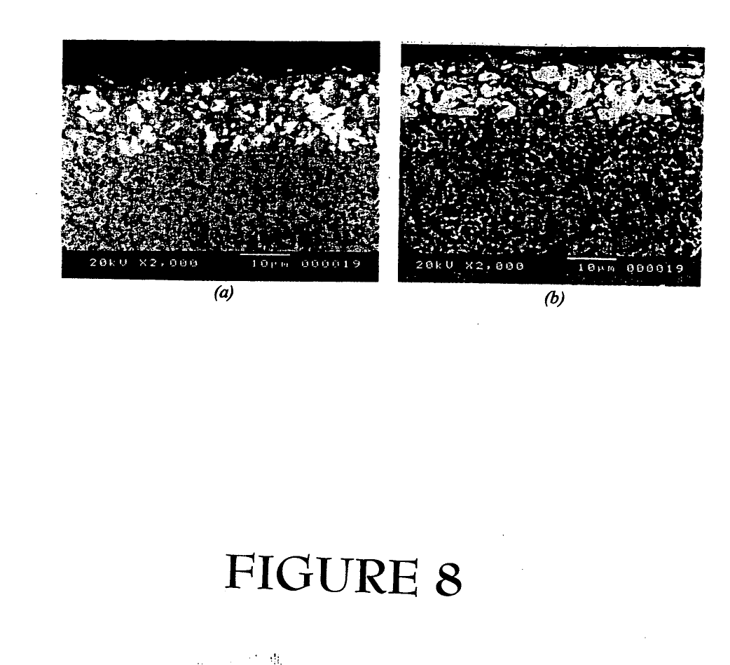

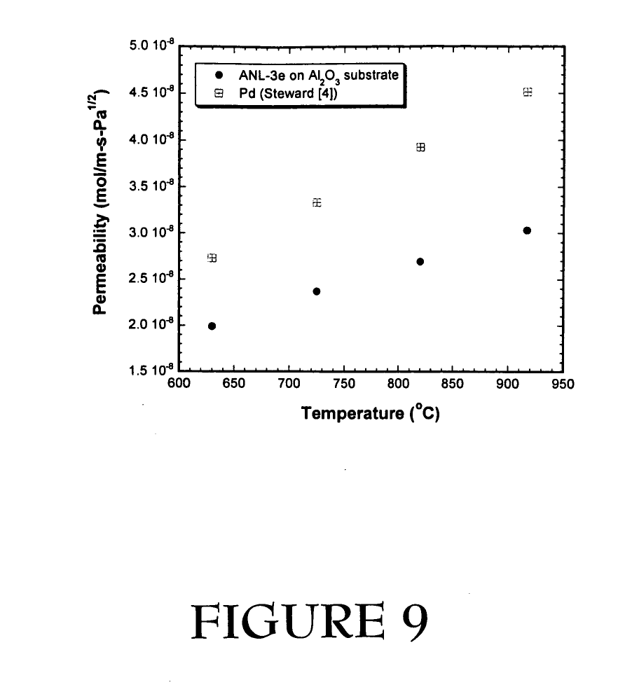

FIG. 7 shows the hydrogen flux as a function of temperature and as expected, the H₂ flux increased linearly with the difference in pH₂^{1/2} for the feed and sweep gases. This type of pH₂ dependence was also found for stand-alone ANL-3e membranes (i.e. dense membranes not supported by porous substrates), and typifies the diffusion of atomic hydrogen through a metal. SEM micrographs (FIG. 8) show that the pores are larger in the sample re-sintered at 1500° C. Although other factors (e.g., Pd grain size) are also involved, these results suggest that the hydrogen flux is increased by an increase in the size of pores in the substrate.

ANL-3e (60 vol. % Pd) thin films were also made on porous Al₂O₃ substrates. Sintering at 1400° C. for 5 h in air produced a dense film (judging by the observation that isopropyl alcohol did not penetrate it) with a thickness of about 40 μm. Its hydrogen flux at 900° C. was about 20 cm³(STP)/min-cm² using 80% H₂/balance He as the feed gas. FIG. 8 shows that the permeability for the membrane is only slightly lower than that for pure Pd, which is not bad, considering the film's significantly lower volume fraction of Pd.

The inventive paste method is applicable for preparing thin 5-50 micron membranes for both HTM and OTM species. For HTM membranes the metal powder used in the two part HTM membranes preferably has an average diameter in the range of from about 0.1 to about 5 microns and more preferably in the range of from about 1 to about 3 microns and most preferably an average diameter of about 2 microns. The hydrogen transfer membranes are preferably 96% of theoretical density and most preferably about 98% of theoretical density. The thickness of the membranes, as before stated is about 5 to 50 microns, preferably 5 to 20 microns and most preferably about 10 microns, it being understood that thinner is better due to the improved hydrogen flux through the membrane for thinner membranes.

An important feature of the present invention is that with the paste method, it is possible to provide two different materials that have coefficients of expansion which are relatively close, it being preferred that the coefficience for the expansion of the membrane be less than about 10% different than for the substrate. In some cases, the ceramic substrate and the ceramic oxide portion of the membrane may be the same or substantially the same. While there are a variety of metals which are useful as the metal powder part of a two part hydrogen permeable membrane such as Ni, Pd, Pd alloys, Nb, Ta, Zr, V or various mixtures thereof, the preferred metal is Pd or a Pd—Ag alloy or mixture thereof. Moreover, the ceramic portion of the two-part membrane may be a variety of materials, for instance yttria stabilized zirconia, shrinkable alumina, the cerates, titanate or zirconates of barium or strontium and mixtures thereof but the preferred oxide is the yttria stabilized zirconia. Where alumina is used, the alumina should be capable of shrinking upon sintering in air and to this end, an alumina with about 10% water has been found particularly satisfactory. It has been found that the hydrogen flux through the membranes is improved or can be improved by varying the heat treatment of the membrane. For instance, after the paste has been applied, the membranes can be heated at a variety of temperatures generally above 1000° C. As previously discussed, membranes which have been heated to 1400° C. for a period of time and thereafter at 1500° C. seem to have an improved flux.

The paste composition as previously discussed is a mixture of the various parts in a vaporizable liquid vehicle, usually an organic. The preferred organics are a combination of alpha terpineol and isopropyl alcohol as previously discussed. Also, various binders and plasticizers as are well known in the art may be used in combination with the organic vehicle, all or most of which is removed during sintering.

It has been shown that the method of producing hydrogen transfer membranes according to the paste or inventive method produces superior hydrogen transport where the metal powder in the two-part membrane is present in the range from about 20 to about 80% by volume, producing hydrogen flux at at least 20 cm² at 500° C. and 100% hydrogen atmosphere and over 30 cm³ μm-cm² at 900° C. and 100% hydrogen atmosphere. Obviously, the greater the hydrogen concentration gradient across the membrane the more improved the flux will be for a given temperature pressure and other conditions.

Also as disclosed herein, improved oxygen permeable membranes may be prepared by the present paste method utilizing those compounds previously identified as water splitting compounds in U.S. Pat. No. 6,726,893 issued Apr. 27, 2004, the entire disclosure of which is herein incorporated by reference. The oxygen transfer membranes operate by water splitting when water comes in contact with the surface of the membrane and is disassociated into hydrogen atoms and oxygen atoms with the oxygen atoms passing through the membrane leaving the hydrogen atoms on the original side. As is well known, thermodynamics insures that water splitting continues under these circumstances, thereby increasing hydrogen concentration. Both one part or two part membranes are capable of being manufactured by the method herein described. For one-part membrane, the oxygen permeable composition is one or a mixture of Sr(Fe_{1-y}Co_{y})Oₓ or Sr(Fe1−yTi_{y})Oₓ. The oxygen permeable composition may also be formed of a two part membrane in which a metal powder part is selected from Ni, Ag, or Fe or alloys or mixtures thereof with Ni being preferred while the oxide part may be selected from CeO₂ doped with lower valence atoms, Gd being preferred or Zr being suitably doped with a lower valence atoms usually from the lanthanides, or a SrFeCo_{0.5}Oₓ or various mixtures thereof. Doping of these membranes is within the skill of the art. These membranes can be made very thin, also less than about 20 microns and preferably less than about 10 microns and exhibit good if not superior oxygen permeability.

While the invention has been particularly shown and described with reference to a preferred embodiment hereof, it will be understood by those skilled in the art that several changes in form and detail may be made without departing from the spirit and scope of the invention.

The embodiments of the invention in which an exclusive property or privilege is: claimed are defined as follows:

1. A hydrogen permeable composition, comprising a porous ceramic substrate,
and a two part membrane adhered to said porous ceramic substrate,
said two part membrane having a metal powder part and a ceramic oxide part,
said metal powder part being selected from Ni, Pd, Pd alloys, Nb, Ta, Zr, V or mixtures thereof,
said oxide part being selected from yttria stabilized zirconia , shrinkable alumina, suitably doped cerates, titanates, zirconates of barium or strontium or mixtures thereof,
wherein said metal powder part is present in the range of from about 20 to about 80 percent by volume of said membrane and the hydrogen flux is at least 20 cm³ per minute-cm² at 500° C. in a 100% hydrogen atmosphere.

2. The combination of claim 1, wherein said metal powder has an average diameter in the range of from about 0.1 to about 5 microns.

3. The combination of claim 1, wherein said metal powder has an average diameter in the range of from about 1 to about 3 microns.

4. The combination of claim 1, wherein said metal powder has an average diameter of about 2 microns.

5. The combination of claim 1, wherein said two part membrane is at least 96% of theoretical density.

6. The combination of claim 1, wherein said two part membrane is at least 98% of theoretical density.

7. The combination of claim 1, wherein said two part membrane has a thickness in the range of from about 5 to about 50 microns.

8. The combination of claim 1, wherein said two part membrane has a thickness in the range of from about 5 to about 20 microns.

9. The combination of claim 1, wherein said two part membrane has a thickness of about 10 microns.

10. The combination of claim 1, wherein the coefficient of thermal expansion of said porous ceramic substrate and said two part membrane are within about 10% of each other.

11. The combination of claim 1, wherein said porous ceramic substrate and said ceramic oxide part of said two part membrane are substantially the same.

12. The combination of claim 1, wherein said porous ceramic substrate and said two part membrane are substantially the same.

13. The combination of claim 1, wherein said metal part of said two part membrane is Pd or a Pd—Ag alloy and/or mixture and said ceramic oxide part is yttria stabilized zirconia.

14. The combination of claim 13, wherein said substrate is alumina capable of shrinkage upon sintering in air at temperatures above 1000° C.

15. The combination of claim 1, wherein the hydrogen flux is at least 30 cm³ per minute-cm² at 900° C. in an 100% hydrogen atmosphere.

16. The combinations of claim 1, wherein the dopants for the cerates, titanate and zirconates of barium or strontium or mixtures thereof are metals with a valence of less than four.

17. A paste composition for forming a hydrogen permeable two part membrane, comprising
a vaporizable liquid vehicle and a sinterable powder homogeneously dispersed therein,
said powder including a metal powder part and a ceramic oxide powder part, said metal powder part being selected from Ni, Pd, Pd alloys, Nb, Ta, Zr, V or mixtures thereof,
said oxide part being selected from yttria stabilized zirconia, shrinkable alumina, suitably doped cerates, titanates, zirconates of barium or strontium or mixtures thereof,
wherein said metal powder part is present in the range of from about 20 to about 80 percent by volume of said membrane and the hydrogen flux is at least 20 cm³ per minute-cm² at 500° C. and at least 30 cm³ per minute-cm² at 900° C. in an 100% hydrogen atmosphere.

18. The paste composition of claim 17, wherein said vaporizable liquid vehicle includes α-terpineol.

19. The paste composition of claim 17, wherein said vaporizable liquid vehicle includes isopropyl alcohol.

20. The paste composition of claim 17, wherein said vaporizable liquid vehicle includes α-terpineol and isopropyl alcohol.

21. The paste composition of claim 17, wherein said vaporizable liquid vehicle includes a binder and/or a plasticizer.

22. The paste composition of claim 17 and further including a porous substrate with said paste composition layered on one surface of said substrate.

23. The past composition of claim 17, wherein the dopants for the cerates, titanate and zirconates of barium or strontium or mixtures thereof are metals with a valence of less than four.

24. A method of extracting hydrogen from a fluid stream containing hydrogen molecules, comprising
contacting one surface of a two part membrane with the fluid stream thereby establishing a hydrogen molecule concentration gradient across the two part membrane, and
passing hydrogen atoms through the two part membrane from the side of higher concentration to side of lower concentration,
the two part membrane containing a metal powder part and a ceramic oxide part,
the metal powder part being selected from Ni, Pd, Pd alloys, Nb, Ta, Zr, V or mixtures thereof, the oxide part being selected from yttria stabilized zirconia , a shrinkable alumina suitably doped cerates, titanates, zirconates of barium or strontium or mixtures thereof,
wherein the metal powder part is present in the range of from about 20 to about 80 percent by volume of the membrane and the hydrogen flux is at least 20 cm³ per minute-cm² at 500° C. in a 100% hydrogen atmosphere.

25. The method of claim 24, wherein the metal part is Pd and/or a Pd-Ag alloy thereof and the two part membrane thickness is less than about 20 microns.

26. The method of claim 24, wherein the two part membrane is sintered in air at a temperature up to about 1500° C.

27. The method of claim 24, wherein the two part membrane is sintered at a temperature below about 1 500° C. for a time and thereafter sintered at a temperature of about 1500° C. for a time.

28. An oxygen permeable composition, comprising a porous ceramic substrate, and
a one part or a two part membrane adhered to or integral with said porous ceramic substrate,
said one part membrane being selected from one or more of Sr(Fe_{1-y}Co_{y})Oₓ or Sr(Fe_{1-y}Ti_{y})Oₓ or mixtures thereof, said two part membrane having a metal powder part and a ceramic oxide part, said metal powder part being selected from Ni, Ag, Fe, alloys or mixtures thereof, said oxide part being selected from CeO₂ doped with lower valence metal atoms, ZrO₂ doped with lower valence metal atoms, Sr FeCo_{0.5}Oₓ or mixtures thereof,
wherein said metal powder part is present in the range of from about 20 to about 80 percent by volume of said membrane.
